(19) United States
(12) Patent Application Publication
(10) Pub. No.: US 2016/0116302 A1
(43) Pub. Date: Apr. 28, 2016

(54) METHOD FOR COMPARING TWO INERTIAL UNITS INTEGRAL WITH A SAME CARRIER

(71) Applicant: SAGEM DEFENSE SECURITE, Boulogne Billancourt (FR)

(72) Inventors: Christian LIGNON, Boulogne Billancourt (FR); Nicolas GENDRE, Boulogne Billancourt (FR)

(21) Appl. No.: 14/655,523

(22) PCT Filed: Dec. 23, 2013
(86) PCT No.: PCT/EP2013/077953

§ 371 Date: Nov. 27, 2015

(30) Foreign Application Priority Data
Dec. 26, 2012 (FR) 12 03593

(51) Int. Cl. G01C 25/00

(52) U.S. Cl. CPC G01C 25/005

(57) ABSTRACT

A method for comparing two inertial guidance systems which are integral with a carrier in positions that are separated from one another and which each comprise three angular measurement sensors and three accelerometric sensors mounted along the axes of a measurement reference frame specific to each inertial guidance system, the method comprising the steps for:
over a pre-determined period of time, measuring a specific force and rotations respectively with the accelerometric sensors and the angular sensors of each inertial guidance system,
correcting for a cantilever effect in order to bring the reference frames to the same origin,
reconstructing an inertial reference frame for each inertial guidance system using the specific force and rotations thus measured,
comparing the inertial reference frames in order to determine a separation between them.

The present invention relates to the transfer of attitude (in other words the orientation of the carrier in an inertial reference frame) from one inertial guidance system to another inertial guidance system.

An inertial guidance system comprises accelerometric sensors and angular sensors of the gyroscope or gyrometer type which are mounted on the axes of a measurement reference frame specific to the inertial guidance system. The sensors are connected to the processing unit configured for processing the signals coming from the sensors in such a manner as to supply navigational data, namely an attitude, a speed and a position of the carrier vehicle to which the inertial guidance system is fixed.

Sometimes the same vehicle carries on board two inertial guidance systems having different performance characteristics such as for example an inertial guidance system with a short-term precision but unusable over the long term, and an inertial guidance system with a long-term precision but exhibiting significant cyclical errors over the short to medium term. A good precision of the navigation data over the short, medium and long term is obtained by comparing navigational data, generally the speed or the position, supplied by the two inertial guidance systems. This comparison is carried out by means of a Kalman filter in order to determine an error model. It is thus possible to estimate and correct for the errors of the accelerometric sensors and of the angular sensors. However, the comparison is carried out on a data value resulting from a navigation calculation which is also influenced by errors linked to the processing unit generating positions or speeds. Furthermore, the use of a data value coming from the processing unit renders tricky any filtering which would allow the comparison to be facilitated or the reliability of the latter to be enhanced. One aim of the invention is to provide a means for estimating the orientation of an inertial guidance system based on measurements from another inertial guidance system.

For this purpose, according to the invention, a method is provided for comparing two inertial guidance systems which are integral with a carrier in positions that are separated from one another and which each comprise three angular measurement sensors and three accelerometric sensors mounted along the axes of a measurement reference frame specific to each inertial guidance system, the method comprising the steps for:
over a pre-determined period of time, measuring a specific force and rotations respectively with the accelerometric sensors and the angular sensors of each inertial guidance system,
correcting for a cantilever effect in order to bring the reference frames to the same origin,
reconstructing an inertial reference frame for each inertial guidance system using the specific force and rotations thus measured,
comparing the inertial reference frames in order to determine a separation between them.

Thus, the method of the invention carries out a comparison of the reference frames of the inertial guidance systems, these reference frames being obtained from the specific force determined by the accelerometric sensors and the rotations measured by the angular sensors. However, in view of the invariance of the specific force at a point in any given inertial reference frame (in other words the two inertial guidance systems measure the same physical quantity), it is possible to filter this quantity with a view to improving the reliability of the comparison.

According to particular features:
the reconstruction of the specific force in an inertial reference frame is achieved by calculating a signal corresponding to the product of the specific force measured in the sensor reference frame and of a rotation matrix coming from the integration of the measurement of the rotation increments, this signal being subsequently subject to a low-pass filtering and an under-sampling;
the predetermined period of time is substantially equal to the error excitation period of that of the inertial guidance systems exhibiting the lowest short-time reliability;
one of the inertial guidance systems being a rollover inertial guidance system, the period is equal to at least the duration of one full rollover cycle;
the period is of the order of at least a few minutes;
the comparison is carried out by calculating a rotation matrix between the two inertial reference frames.

Other features and advantages of the invention will become apparent from reading the description that follows of one particular non-limiting embodiment of the invention.

Reference will be made to the appended drawings, amongst which:

FIGS. 1 to 12 are block diagrams showing the various steps of the method according to one preferred embodiment of the invention;

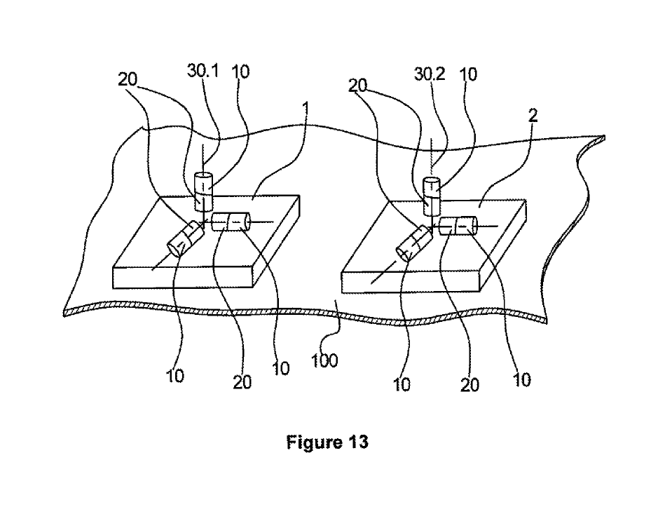

FIG. 13 is a schematic view of a carrier equipped with two inertial guidance systems allowing the implementation of the method of the invention.

FIG. 13 shows a carrier 100 such as an aircraft or a sea craft. Two inertial guidance systems 1, 2 (or inertial systems for an inertial measurement unit) are integral with the carrier 100 in positions that are separated from one another. Each inertial guidance system 1, 2 comprises three angular measurement sensors, here gyroscopes 10, and three accelerometric sensors 20 mounted along the axes of a measurement reference frame 30.1, 30.2 specific to each inertial guidance system 1, 2.

The inertial guidance systems 1 and 2 have different performance characteristics: for example the inertial guidance system 1 has better performance characteristics over the short and the medium term than the inertial guidance system 2, whereas the inertial guidance system 2 has better performance characteristics over the long term than the inertial guidance system 1. The inertial guidance systems 1, 2 may use the same technology or different technologies. The inertial guidance systems may thus comprise vibrating resonator sensors, fiber optic sensors, etc. The inertial guidance systems may be fixed (‘strap down’ type) or carried by a stabilization chassis or a chassis articulated in order to provide successive rollovers of the inertial guidance systems.

The inertial guidance systems 1, 2 are connected to a navigational unit 40 programmed for implementing the method of the invention whose operation is described hereinafter.

The method comprises the steps for:
over a pre-determined period of time, determining a specific force and rotations respectively with the accelerometric sensors and the angular sensors of each inertial guidance system,
correcting for a cantilever effect in order to bring the reference frames to the same origin,
reconstructing an inertial reference frame for each inertial guidance system using the specific force and rotations thus measured,
comparing the inertial reference frames in order to determine a separation between them.

More precisely, a characteristic period of time is pre-determined as a first stage. This period is preferably equal to the excitation period of the errors of the least reliable inertial guidance system over the short term, here this being the inertial guidance system 2. Typically, for a rollover inertial guidance system, the duration of the full rollover cycle is used. The cycle duration must be of the order of at least a half-hour in order to avoid a division by zero or too great a vulnerability to noise on the operations in FIG. 4.

The signal in question is an increment in speed Δv_i in the calculation inertial reference frame of each inertial guidance system. The increments in speed Δv_i (which relate to the three axes of the calculation inertial reference frame and may therefore be modeled numerically in the form of a [3×1] matrix as indicated in the figures for each quantity that can be) are obtained by multiplying the increments in speed Δv_m (which are supplied by the accelerometers of each inertial guidance system) by the rotation matrix Tim ([3×3] matrix) obtained by integrating the angular increments Δθ_m of the gyroscopes at each moment in time over the characteristic period (FIG. 1).

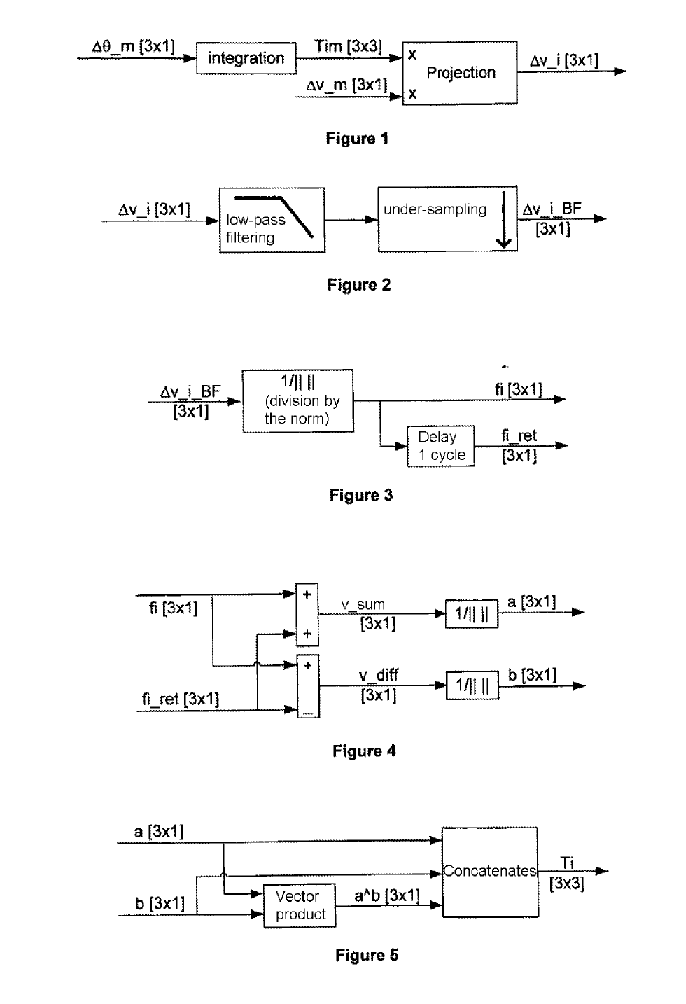

The increments in speed Δv_i are subjected to a low-pass filtering, then are under-sampled in order to obtain low-frequency increments in speed Δv_i_BF (FIG. 2). The under-sampling period is for example in the range between 3 and 30 seconds. The low-pass filter may be of various types, but must ensure compliance with the Shannon criterion for the under-sampling. It will be noted that this filtering is made possible by the invariance of the specific force at a point in any given inertial reference frame. Furthermore, since the increments Δv_i in question are signals with three components, the filtering is applied independently on the three channels.

The low-frequency increments in speed Δv_i_BF are subsequently normed. The normed increments go into a memory queue, which allows for the next step to simultaneously use the last normed increment produced fi, and a normed increment delayed by exactly one cycle fi_ret (FIG. 3). The normed increments fi and fi_ret may be modeled numerically in the form of a [3×1] matrix. The normed increments fi and fi_ret are representative of the specific force and are different from each other for the same inertial guidance system owing to the Earth's rotation having taken place during the cycle being considered. The normed increments fi and fi_ret determined for the inertial guidance system 1 should be respectively identical to those determined for the inertial guidance system 2, with the exception of the influence of the cantilevers resulting from the difference in position between the two inertial guidance systems 1 and 2. In order to avoid their influence, the cantilevers are corrected in a initial step in a conventional manner.

The sum v_sum and the difference v_diff of the two normed increments fi and fi_ret are calculated. The vectors a and b are the vectors obtained by norming the sum and the difference (FIG. 4).

A [3×3] matrix Ti is subsequently determined by concatenation. The three columns of the matrix Ti are the vector a, the vector b, and their vector product âb (FIG. 5).

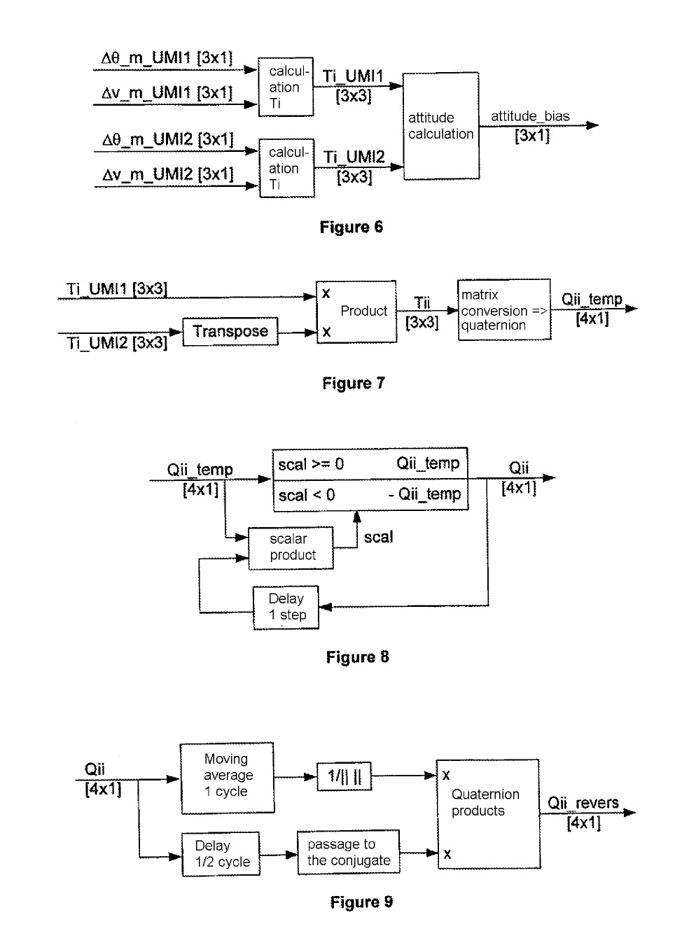

All the operations described up to now are applied to both of the two inertial guidance systems, which allows two matrices Ti_UMI1 and Ti_UMI2 to be produced whose calculation is completely independent (FIG. 6). However, the cycle duration used in the calculation must be the same. In this figure, the increments in speed Δv_m_UMI1, Δv_m_UMI2 are respectively supplied by the accelerometers of each inertial guidance system 1, 2 and the angular increments Δθ_m_UMI1, Δθ_m_UMI2 are respectively supplied by the gyroscopes of each inertial guidance system 1, 2.

The matrices Ti_UMI1 and Ti_UMI2 are used as a basis for the attitude calculations allowing attitude biases, denoted attitude_bias in FIG. 6, to be determined. These calculations of attitude bias are described with reference to FIGS. 7 to 10.

The rotation matrix Tii allowing the passage from the matrix Ti_UMI1 to the matrix Ti_UMI2 is subsequently calculated. The matrix Tii is a [3×3] matrix obtained by multiplying the matrix Ti_UMI1 by the transpose of the matrix Ti_UMI2. The quaternion Qii_temp is deduced from this (FIG. 7). The algorithms for transformation of a [3×3] matrix into a [4×1] quaternion are in the public domain.

The quaternion Qii (see FIG. 8) is obtained by simply setting the sign of Qii_temp in coherence with the result scal of the scalar product of the quaternion Qii_temp and of the quaternion Qii of the preceding time step. The quaternion Qii represents an instantaneous value (here the term ‘instantaneous’ is used as opposed to an average value mentioned hereinbelow and obtained over a longer integration time).

Qii then goes into a memory queue comprising the values over a period of one cycle (FIG. 9).

Two intermediate quaternions are calculated. The first intermediate quaternion is the moving average over one cycle of Qii (component by component average) which is subsequently normed (so that the result is a unitary quaternion, hence a rotation quaternion). The first intermediate quaternion therefore represents an average value. The second intermediate quaternion is the conjugate of the quaternion Qii, delayed by a half-cycle. The intermediate product Qii_revers of the two quaternions results from the multiplication of the two intermediate quaternions. The product Qii_revers thus represents the differences of the instantaneous rotation matrix with respect to an average rotation matrix.

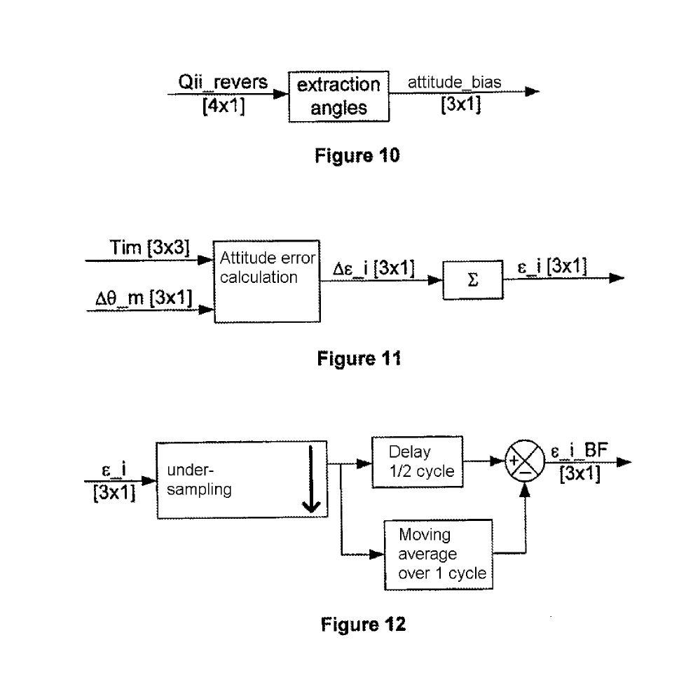

The attitude bias angles attitude_bias are obtained by performing the extraction of the rotation vector from Qii_revers (FIG. 10). Various methods (those employing the assumption of small angles yield very simple calculations) allow the inversion of the formula:

$$Q = [ cos ( \frac{‖ \vec{B} ‖}{2} ) \frac{\vec{B}}{‖ \vec{B} ‖} sin ( \frac{‖ \vec{B} ‖}{2} ) ] ,$$

\vec{B} being the composite vector of the three attitude bias angles.

In parallel, the matrix Tim and the increments Δθ_m are used to calculate, for each error term of the model, an estimation of the errors (predicted) in attitude ε_i that it generates (FIG. 11).

These predicted errors ε_i are under-sampled, then the low-frequency values are, on the one hand, averaged (moving average over one cycle) and, on the other hand, delayed prior to subtracting the averaged low-frequency values from the delayed low-frequency values (FIG. 12). A “difference from the mean” ε_i_BF is thus calculated, in phase with the attitude bias attitude_bias calculated by the chain in FIG. 10.

According to a time slicing determined in advance (fixed as a function of the excitations to which one of the inertial guidance systems is subjected), the attitude biases, in the same way as the predicted errors, are put into a memory stack in order to allow the identification of a model as a function of ε_i_BF aiming to compensate the attitude biases.

The method of the invention assumes that the accelerometric errors are corrected beforehand by an accelerometric model. A measurement of the relative gyrometric errors is also carried out. This measurement is carried out thanks to the variations in attitude or for example with respect to a known gyroscopic model or by performing cyclic maneuvers of one of the guidance systems (for example a rollover). It would also be possible to measure the differences in attitude by using dedicated means such as angular encoders, a camera, optical means, etc.

It goes without saying that the invention is not limited to the embodiments described but encompasses any variant coming into the scope of the invention such as defined by the claims.

1. A method for comparing two inertial guidance systems which are integral with a carrier in positions that are separated from one another and which each comprise three angular measurement sensors and three accelerometric sensors mounted along the axes of a measurement reference frame specific to each inertial guidance system, the method comprising the steps for:
over a pre-determined period of time, measuring a specific force and rotations respectively with the accelerometric sensors and the angular sensors of each inertial guidance system,
correcting for a cantilever effect in order to bring the reference frames to the same origin,
reconstructing an inertial reference frame for each inertial guidance system using the specific force and rotations thus measured,
comparing the inertial reference frames in order to determine a separation between them.

2. The method as claimed in claim 1, in which the comparison of the two inertial reference frames is carried out in order to determine an instantaneous rotation matrix between the inertial reference frames.

3. The method as claimed in claim 2, in which biases in attitude and errors in attitude are determined based on differences between the instantaneous rotation matrix and a average rotation matrix, and the method comprises a step for introducing the biases and the errors in attitude into a model aiming to compensate the differences in attitude.

4. The method as claimed in claim 2, in which the reconstruction is carried out by calculating a signal corresponding to the product of the increments in speed used for the determination of the specific force and of the instantaneous rotation matrix, this signal being subsequently subjected to a low-pass filtering and an under-sampling complying with the Shannon criterion.

5. The method as claimed in claim 2, in which the pre-determined period is substantially equal to the error excitation period of that of the inertial guidance systems exhibiting the lowest short-term reliability.

6. The method as claimed in claim 5, in which, one of the inertial guidance systems being a rollover inertial guidance system, the period is equal to at least the duration of one full rollover cycle.

7. The method as claimed in claim 5, in which the period is of the order of at least a half-hour.
